(19) United States
(12) Patent Application Publication
(10) Pub. No.: US 2009/0310473 A1
(43) Pub. Date: Dec. 17, 2009

(54) OPTICAL DATA CARRIER AND METHOD FOR READING/RECORDING DATA THEREIN

(75) Inventors: Kanji Katsuura, Saitama-ken (JP); Rene Hamer, Louisville, CO (US); Yair Salomon, Jerusalem (IL)

Correspondence Address: BROWDY AND NEIMARK, P.L.L.C.;624 NINTH STREET, NW, SUITE 300, WASHINGTON, DC, 20001-5303, US

(73) Assignee: Mempile Inc., Wilmington, DE (US)

(21) Appl. No.: 12/162,338

(22) PCT Filed: Jan. 18, 2007
(86) PCT No.: PCT/IL07/00069

§ 371 Date: Apr. 3, 2009

Related U.S. Application Data
(60) Provisional application No. 60/759,580, filed on Jan. 18, 2006.

(51) Int. Cl. G11B 7/24; B32B 7/02; B32B 3/10

(52) U.S. Cl. 369/275.4; 428/212; 428/172; 428/195.1; G9B/7

(57) ABSTRACT

An optical data carrier is presented. The data carrier comprises at least one recording layer, at least one non-recording layer, and at least one reflective interface. The recording layer is made of a material having a fluorescent property variable on occurrence of multi-photon absorption resulted from an optical beam, and has a thickness for recording therein data in the form of a three-dimensional pattern of spaced-apart recording regions arranged in a plurality of recording planes. The at least one non-recording layer interfaces with the recording layer on, respectively, at least one of upper and lower surfaces of the recording layer The non-recording layer has a fluorescent property different from that of the recording layer, and has a predetermined thickness selected to be equal or larger than a focal depth of an optical system producing the optical beam incidence onto the data carrier. The at least one reflective interface comprises at least one reference layer having a reflecting property. The at least reflective layer is formed on the other surface of the at least one non-recording layer, respectively, such that the non-recording layer in sandwiched between the reference layer and the recording layer.

### FIELD OF THE INVENTION

The present invention is in the field of optical data carriers, and relates to a multi-layered optical data carrier and a method of recording/reproducing data therein. More particularly, the invention relates to an optical data carrier including recording and reference layers, where information is recorded on a plurality of recording planes in the recording layer.

### BACKGROUND OF THE INVENTION

The existing approach for optical data carriers is based on the use of reflective media. Accordingly, commercially available optical data carriers have one or two data layers, where in the latter case; the two layers are separated by a distance of about 50 microns.

Various techniques have been developed in the field of optical recording media to provide fine-patterned pit length and track pitch, to shorten the laser wavelength, and to increase the recording density by using the increased numerical aperture (NA) of an objective lens.

In recent years, for the purpose of a further increase in the recording density, recording media have been proposed that include multi-layered recording planes. When a recording light beam is focused on a position at a higher optical intensity, the optical interaction property (e.g. reflectivity) of the recording layer varies only on the focused position, resulting in data recording.

Data recording in such multi-layered optical recording medium requires precise control of the beam spot of a recording/reproducing beam to a desired position in the thickness direction of the medium, or the focus direction. For example, U.S. Pat. Nos. 5,408,453 and 6,538,978 disclose an optical information storage system having a multi-recording-layer record carrier and a scanner device for the carrier. The scanner produces a radiation beam which is compensated for spherical aberration for a single height of the scanning spot with the stack of layers. The height of the stack is determined by the maximum spherical aberration permissible for the system. The number of layers in the stack is determined by the minimum distance between layers, which depends on the crosstalk in the error signals due to currently unscanned layers.

Another recently developed technique for a multi-layered recording scheme employs a recording medium having a fluorescent property variable on occurrence of single- or multi-photon absorption (see for example WO 2004/032134 assigned to the assignee of the present application). In this scheme, recorded data is in the form of a three-dimensional pattern of spaced-apart data spots, such that the recording plane is not physically formed. Therefore, the conventional scheme cannot be used for precise recording in a recording plane on a desired position.

### SUMMARY OF THE INVENTION

The present invention is aimed at providing a novel optical data carrier configured to enable recording data in and reproducing (reading) data from multiple recording planes, which are located within at least one recording layer (recording medium). To this end, the data carrier of the present invention utilizes one or more reference layers presenting reflective surface(s), and one or more non-recording layers. The present invention also provides a method for recording/reproducing data in/from such a data carrier.

According to one broad aspect of the invention, there is provided an optical data carrier, comprising:

at least one recording layer comprised of a material having a fluorescent property variable on occurrence of multi-photon absorption resulted from an optical beam, said recording layer having a thickness for recording therein data in the form of a three-dimensional pattern of spaced-apart recording regions arranged in a plurality of recording planes;

at least one non-recording layer interfacing with said recording layer on, respectively, at least one of upper and lower surfaces of said recording layer, said at least one non-recording layer having a fluorescent property different from that of said recording layer, said non-recording layer having a predetermined thickness selected to be equal or larger than a focal depth of an optical system producing said optical beam incidence onto the data carrier; and

at least one reflective interface comprising at least one reference layer having a reflecting property, said at least reflective layer being formed on the other surface of said at least one non-recording layer, such that the non-recording layer in sandwiched between the reference layer and said recording layer.

It should be understood that different fluorescent properties of the recording and non-recording layers can be achieved for example by providing the recording layer which in non-recorded state is fluorescent while the non-recording layer is a non-fluorescent layer; or by providing the recording layer, which in its non-recorded state is non-fluorescent, while the non-recording is fluorescent.

Preferably, the non-recording layer is made of an adhesive material to enable adhering of the recording layer to the reference layer. For example, the thickness of the non-recording layer may be in the range of 3 μm to 80 μm.

The reflective interfaces may be constituted by the reflective reference layer spaced from the recording layer by the non-recording layer, or may be an interface between the non-recording layer and the recording layer formed by a difference in refractive indices of the recording and non-recording layers' materials.

The reference layer has a pattern configured to enable tracking of the optical reference beam, based on reflections of the optical beam from this pattern. The pattern may comprise a plurality of discrete pits; or may comprise a plurality of concentric circular grooves or a spiral groove; or a combination of the above, namely groove(s) with discrete pits therein.

The pattern in the reference layer may be configured to enable tracking of the optical beams of different wavelengths, based on reflections of the optical beam from the pattern. These optical beams of different wavelengths are recording/reproducing and reference beams.

In those embodiments of the invention, where the pattern in the reference layer is in the form of the plurality of concentric grooves or a spiral groove, the groove depth may be of about λ₁/8n₁. Here, n₁ is a refractive index of the non-recording layer interfacing with the reference layer upstream thereof in a direction of propagation of the optical beam towards the reference layer, at wavelength λ₁ of the reference beam.

In those embodiments of the invention, where the pattern in the reference layer is formed by the plurality of pits, arranged either along a plurality of concentric circular arrays or along spiral paths, the plurality of pits may include pits of a depth of about λ₁/4n₁; or of a depth of about λ₁/6n₁.

As indicated above, the pattern in the reference layer may be configured to enable tracking of the recording/reproducing beam based on reflection of this beam from said pattern in the reference layer. In these embodiments, considering the pattern in the reference layer formed by a plurality of concentric grooves or a spiral groove, the groove depth may be of about (λ₁/16n₂+λ₁/16n₂). Here, n₁ and n₂ are refractive indices at wavelengths λ₁ and λ₂ of the reference beam and the recording/reproducing beam, respectively, of the non-recording layer interfacing with said reference layer upstream thereof. In case of the pattern formed by a plurality of discrete pits (arranged either in concentric circular arrays or along spiral paths), the plurality of pits may include pits of a depth of about (λ₁/8n₂+λ₂/8n₂); or may include pits of a depth of about (λ₁/2n₂+λ₂/12n₂). In some other examples, the plurality of pits may include pits of a depth d₁=λ₁/4n₂ and d₂=λ₂/4n₂; or pits of a depth d₁=λ₁/6n₂ and d₂=λ₂/6n₂.

The reference layer may comprise position information of radial direction and tangential direction. The reference layer may also comprise information about the thickness of the recording layer.

Preferably, the data carrier configuration is such that the recording layer is enclosed between the first and second non-recording layers, where one of these non-recording layers or both of them at its opposite surface interface with the reflective reference layer.

According to another aspect of the invention, there is provided a method for use in recording/reproducing data in the above-described optical data carrier, said method comprising controlling focusing of the recording/reproducing optical beam on each of multiple recording planes in the recording layer, by detecting at least one of the following: reflection of the recording/reproducing and reference optical beams from the at least one reflective interface, and a change of a fluorescent response from the data carrier at interface between the recording and non-recording layers, to thereby enable at least one of the following: aligning the recording/reproducing beam propagation relative to the reference beam propagation and identifying two opposite interfaces of the recording layer with its surroundings.

In some embodiments of the invention, the above is implemented by controlling an axis of propagation of the recording/reproducing beam towards and inside the data carrier by aligning the axis of propagation of the recording/reproducing beam so as to substantially coincide or be in a desired relation with an axis of propagation of a reference beam. This can be achieved by focusing the reference beam onto a desired track in the reference layer and focusing the recording/reproducing beam at either the same track or a track at a desired relative position with said track onto which the reference beam is being focused.

Preferably, the method utilizes calibration of a moving distance of a focused position of the recording/reproducing beam along a focus direction. This may include locating first and second interfaces of the recording layer at opposite sides thereof, thereby determining a thickness of said recording layer. Generally, the calibration is based on detecting and analyzing light coming from the data carrier in response to the data carrier irradiation by the recording/reproducing beam. This light from the data carrier includes a fluorescent response from the data carrier and/or reflection of the recording/reproducing beam from the data carrier, and is indicative of a distance between the first and second interfaces and therefore the thickness of the recording layer

Thus, in some embodiments of the invention, the calibration includes detecting the fluorescent response from the data carrier, analyzing the detected fluorescent response to detect the change therein, which is indicative of a distance between the first and second interfaces of the recording layer at opposite sides thereof, thereby determining a thickness of the recording layer. In some other embodiments of the invention, the calibration includes determining reflection of the recording/reproducing beam from the at least one reflective reference layer. As indicated above, the optical data carrier may include said recording layer interfacing at opposite sides thereof with respectively first and second non-recording layers, which in turn interface with first and second reflective reference layers.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A to 1C show three examples, respectively, of an optical data carrier configured according to the invention;

FIGS. 2A and 2B illustrate two examples, respectively, of an optical system suitable for recording/reproducing data in the optical data carrier of the invention;

FIG. 3A to 3C show more specifically a patterned reference layer in the optical data carrier configurations of FIGS. 1A-1C, respectively;

FIGS. 4A-4D show some examples of the reference layer pattern: FIG. 4A illustrates the reference layer with concentric grooves; FIG. 4B illustrates the reference layer with a spiral groove; FIG. 4C illustrates the reference layer with a plurality of pits arranged in concentric circular arrays; and FIG. 4D illustrates the reference layer with a spiral array of pits;

FIGS. 5A-5E show several examples of the pit-formed portions in the reference layer suitable to be used in the optical data carrier of the present invention;

FIG. 6 illustrates the principle of the invention for controlling the focusing of the recording/reproducing beam on the interface between the non-recording and recording layers;

FIG. 7 exemplifies a method of the invention for controlling the number of recording planes formed in one recording layer and the interval therebetween;

FIG. 8 exemplifies a wobbling procedure executed for a tracking control, according to the invention;

FIG. 9 shows a relation between the focused position of the recording/reproducing beam (when the position of the recording plane to be read is determined as zero) and the amount of fluorescence received at the detector;

FIG. 10 illustrates a wobbling procedure executed for tracking control during a data reproducing process, according to the invention;

FIGS. 11A and 11B exemplify the wobbling procedures suitable to be used during the data recording and reproducing processes; and

FIGS. 12A-12D and 13 show another example of a wobbling technique used in the present invention.

### DETAILED DESCRIPTION OF EXEMPLARY EMBODIMENTS

Some embodiments of the present invention will now be exemplified with reference to the accompanying drawings.

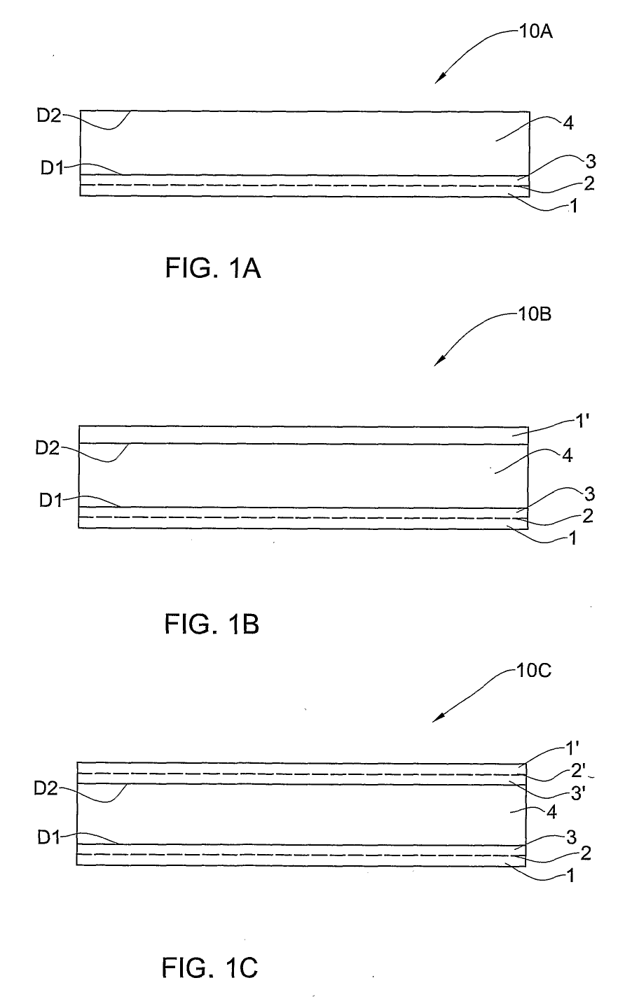

Reference is made to FIGS. 1A to 1C showing three specific but not limiting examples, respectively, of an optical data carrier of the present invention. The same reference numbers will be used for identifying components that are common in the examples of the invention.

FIG. 1A shows schematically an optical data carrier 10A including a recording layer 4 located on top of and in direct contact with a non-recording layer 3, which in turn is located on top of a reference layer 2. The entire stack is supported by a substrate layer 1. The recording and non-recording layers 4 and 3 define a substantially planar interface D₁ between them. In this specific example, the top surface of the recording layer defines the top surface D₂ of the data carrier.

The recording layer 4 serves to record data therein and reproduce the recorded data therefrom, where the data is in the form a three-dimensional pattern of spaced-apart recorded regions arranged in multiple recording planes. The reference layer 2 serves as a reference surface to focus a recording/reproducing light beam on a desired position in the recording layer 4. The substrate 1 serves as a base layer for the reflective reference surface 2 to thereby provide patterns for tracking. The substrate 1 is made of at least one transparent material such as polycarbonate, methacrylic resin, or polyolefin. The non-recording layer 3 and the recording layer 4 material compositions are selected to have different fluorescent properties (as will be described below). The non-recording layer 3 serves for positioning of the recording/reproducing beam by detecting the interface D₁ between the recording and non-recording layers from a change in a fluorescent response.

The recording layer 4 is composed of non-linear medium having a fluorescent property variable on occurrence of multi-photon (two-photon) absorption. Such a recording medium is disclosed in various patent applications and patents assigned to the assignee of the present application. For example Patent Convention Treaty (PCT) publication WO 01/73779 discloses a non-linear three dimensional memory for storing information in a volume comprising an active medium. The active medium is capable of changing from a first to a second isomeric form as a response to radiation of a light beam having energy substantially equal to first threshold energy. The concentration ratio between a first and a second isomeric form in any given volume portion represents a data unit. This PCT publication discloses an optical storage medium that comprises diarylalkene derivatives, triene derivatives, polyene derivatives or a mixture thereof. An optical storage medium with photoactive groups has been disclosed in various PCT publications assigned to the assignee of the present application, for example WO 2006/0117791, WO 2006/075326, WO 2001/073779, WO 2006/075328, WO 2003/070689, WO 2006/111973, WO 2006/075327, WO 2006/075329. As disclosed for example in WO 03/070689, assigned to the assignee of the present application, such material may be a copolymer of 4-methoxy-4′-(8-acryloxyoctyloxy)-trans-α,β-dicyanostylbene (hereinafter referred to as a compound trans-A) and methyl methacrylate, as well as other materials. Plural recording planes, for example, in tens of layers, can be formed in one recording layer 4. The recording layer 4 itself is a bulk substrate, monolithic with respect to the wavelength resolution as discussed in WO 06/075327 assigned to the assignee of the present application. Such a bulk substrate may be composed of a single material having a fluorescent property variable on occurrence of two-photon absorption, and may be a material having a fluorescent property variable on occurrence of two-photon absorption and uniformly dissolved or substantially uniformly organized or dispersed in a substrate material.

The recording layer 4 need not contain any dedicated positional information about either the radial direction (tracking direction) or the data carrier thickness direction (focus direction). Positional information is given from the reference layer 2, as will be described further below, such that data can be recorded with the aid of the tracking direction position signal in the reference layer 2 and the data for setting the focus direction distance from the interface between the recording layer 4 and non-recording layer 3 to the recording plane. As indicated above, the reference layer 2 has a reflecting surface. This can be formed by a film with low reflectance (about 2-50%) evaporated on a pitted/protruded surface, which is pre-formatted in the top surface of the substrate 1 using the well-known stamper. Alternatively, the reflective surface 2 may be formed by an appropriate difference in refractive indices of the substrate 1 and the non-recording layer 3 materials.

The reflecting surface 2 has a certain pattern. In some embodiments of the invention, the pattern may be in the form of a plurality of pits arranged in a spaced-apart relationship either in concentric circular arrays or along a zoned spiral track. In some other embodiments of the invention, the pattern is in the form of either an array of concentric circular grooves or a spiral groove. In yet further embodiments of the invention, the pattern is in the form of a combination of pits and grooves, namely includes a concentric circular array of grooves or a spiral groove, and a plurality of pits arranged in a spaced-apart relationship either inside the groove(s) or in a “land” segments in between the groove segments.

The recording layer 4 is given a thickness in accordance with the pre-designed number of the recording planes for multi-layered recording. The number of the recording planes is determined from the non-linear media response, the optics (e.g. interrogation wavelength or numerical aperture), the accuracy of the recording/reproducing optical system and the dimensional precision of the data carrier itself. For example, to form about 50 recording planes in the recording layer 4, the thickness of the recording layer 4 can be about 300-600 cm.

The non-recording layer 3 serves for adhering the recording layer 4 with the reference layers 2 while keeping these layers substantially parallel to one another. The thickness of the non-recording layer 3 is selected so as to be equal to or preferably larger than the focal depth of an objective lens system used in data recording/reproducing processes (as will be described below). The focal depth of objective lens system is expressed as λ/(NA)², where λ is the wavelength of an optical beam and NA is a numerical aperture of the lens system. For example, the thickness of the non-recording layer 3 is in a range of 3-80 μm. If the thickness of the non-recording layer 3 is smaller than the focal depth, the detection of the interface D₁ between the recording and non-recording layers 4 and 3 might become somewhat inaccurate. The non-recording layer 3 is typically a bonding layer which may be made by spin coating. In order to make the non-recording layer substantially parallel to the recording planes in the recording layer, the thickness of the non-recording layer 3 is preferably from about 5 μm to about 100 μm, and more preferably from about 10 μm to about 50 μm.

The non-recording layer 3 is highly transmitting for wavelength(s) of reference and recording/reproducing beams, while its material composition differs in a fluorescent property from the material of the recording layer 4 used in the data carrier. For example, epoxy resin, a photo-cured acrylic photo-polymerizing adhesive may be employed as the material of the non-recording layer 3. The use of these materials in the non-recording layer will also satisfy a requirement for different fluorescent properties of the recording and non-recording layers. The non-recording layer 3 may be composed of a material having no fluorescent property at all or a material differing in fluorescence emission efficiency or emission wavelength from the recording layer 4. Yet another option is that the recording layer 4 itself is composed of a material which, in its initial non-recording state, has a weak fluorescent property while the non-recording layer 3 is composed of a material having a relatively strong fluorescent property. A copolymer of methyl methacrylate and the 4-methoxy-4′-(8-acryloxyoctyloxy)-cis-α,β-dicyanostylbene (hereinafter referred to as a compound cis-A) may be used in the recording layer 4, while a copolymer of the above compound trans-A and acrylic photo-curing adhesive may be used in the non-recording layer 3. This provides for different fluorescent properties for layers 4 and 3. According to yet other possible option, both the recording layer 4 and the non-recording layer 3 are produced of the isomeric copolymer of the same material, such as the copolymer of the compound A, with one of these layers being made mainly of the compound trans A (trans-rich) and the other being made mainly of the compound cis-A (cis-rich). This also satisfies the requirement for different fluorescent properties in layers 4 and 3. The non-recording layer may be formed of air. As the air layer has no fluorescent property, it is possible to achieve the same effect as the above configuration has.

As will be described further below, focusing of the recording/reproducing beam is controlled by detection of at least one of the following: reflection of the reference beam from the reflective interface(s) in the data carrier, and a fluorescent response from the data carrier. The reflective interface may be constituted by the reflective layer 2 (or two reflective layers 2 and 2′ at opposite sides of the recording layer as will be described below with reference to FIG. 1C). Alternatively the reflective interface may be constituted by the interface D₁ (or interfaces D₁ and D₂ in the examples of FIGS. 1B and 1C), namely an interface between the recording layer and its adjacent layer, created as a result of a difference in the refractive indices of the recording layer material and its adjacent layer material.

More specifically, during recording, focusing of the recording/reproducing beam is controlled by detection of reflection of the reference beam, and during reading, focusing of the recording/reproducing beam is controlled by detection of the fluorescent response and preferably also reflection of the reference beam. It should be noted that when speaking about detection of the fluorescent response for the purposes of controlling the focusing, this fluorescent response may be from the recording layer or from the non-recording layer in accordance with the selected change in the fluorescent property of these layers.

As also will be described more specifically further below, a calibration of the recording/reproducing beam focusing is preferably conducted. In some embodiments of the invention, this calibration is aimed at determining a thickness of the recording layer. This can be implemented by detecting a change in the fluorescent response at the interface between the recording and non-recording layers, and/or by detecting reflection of the reference beam and/or recording/reproducing beam from the reflective interface(s) in the data carrier, based on the known (typically with a high precision) thickness of the non-recording layer(s).

FIG. 1B shows an optical data carrier 10B configured generally similar to the above-described data carrier 10A, but having an additional, uppermost layer 1′ made of a transparent material similar to that of the substrate 1. Here, a surface D₂ is an interface between the recording layer 4 and its surrounding from above, i.e. the top “substrate” 1′. Both the top and bottom layers 1 and 1′ serve as protective layers from scratches or dirt. If both layers 1 and 1′ have substantially the same thickness and are made of the same material, the carrier will thus present a substantially symmetrical structure and will endure the distortion by absorption of humidity.

FIG. 1C shows an optical data carrier 10C having, similar to the above-described data carrier 10B, a top “substrate” 1′, and also having an additional reference layer 21 below the top substrate 1′ and an additional layer 3′ between the upper reference layer 2′ and the recording layer 4. Surfaces D₁ and D₂ are interfaces between, respectively, the recording layer 4 and the non-recording layer 3, and the recording layer 4 and the non-recording layer 3′. This type of carrier has an advantage in that the use of two reference layers 2 and 2′ in association with the common recording layer 4 provides a relatively small distance from a recording plane that has to be covered. It should be noted that the layer 3′ may be a non-recording layer (i.e. which is not intended to recording/reproducing data therein); or may also be a recording layer with a material composition similar or different from the main recording layer(s) (plates) 4.

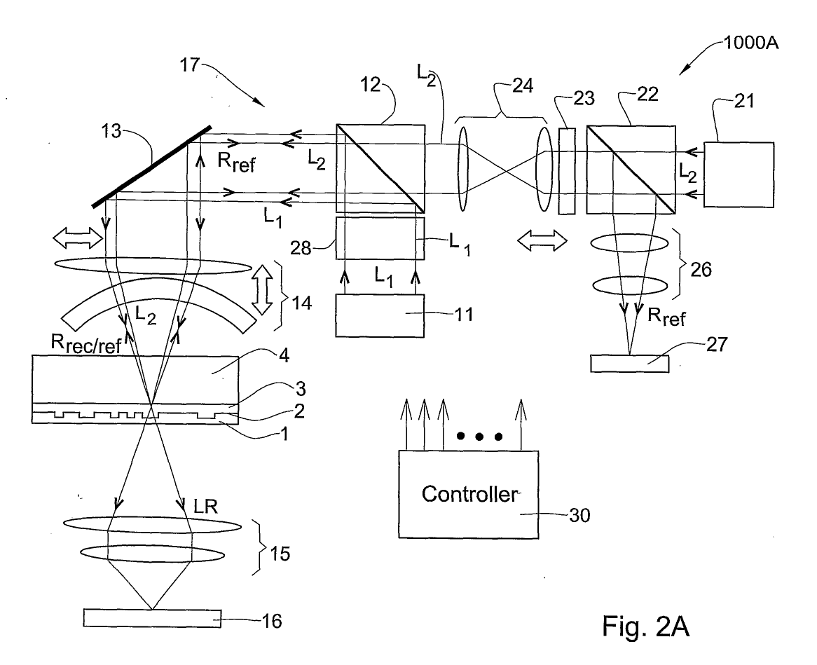

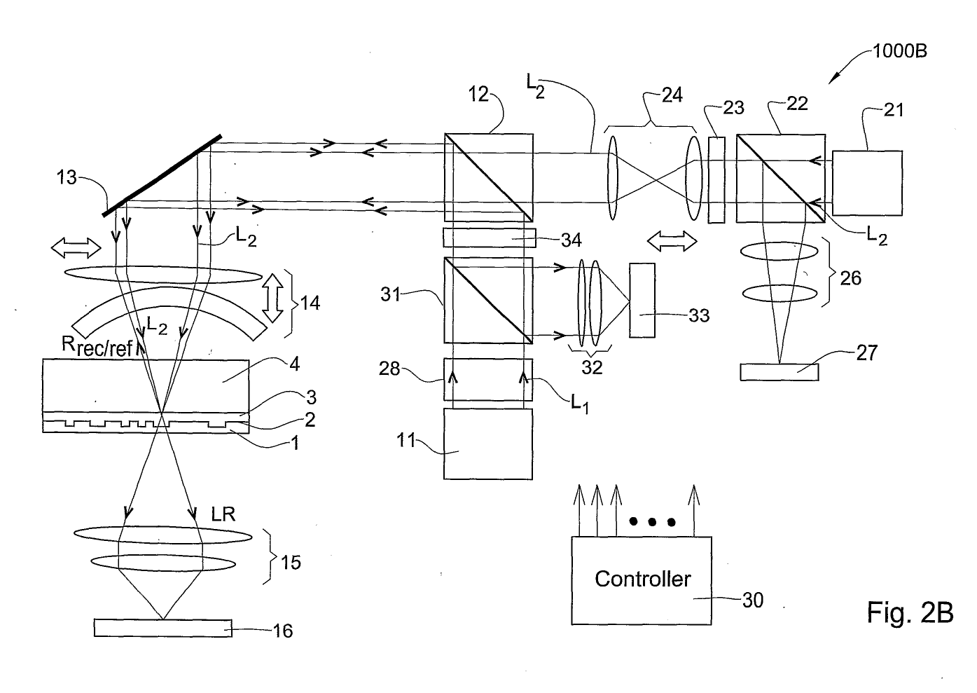

Reference is made FIG. 2A showing an example of the configuration of an optical system, generally designated 1000A, for recording/reproducing data in an optical data carrier 10 (configured as either one of the examples of FIGS. 1A-1C). The data carrier 10 includes at least one substrate layer 1, at least one reflective reference layer 2, at least one non-recording layer 3, and at least one recording layer 4 configured to enable creation therein multiple recording planes. The recording layer 4 is bound substantially parallel to the reference layer 2 through the intermediacy of the non-recording layer 3. The thickness of the non-recording layer 3 is greater than a focal depth of the optical system.

The system 1000A includes a light source system formed by a first light source unit (laser) 11 operative to emit a recording/reproducing light beam L₁, and a second reference light source (laser) 21 operative to emit a reference light beam L₂. The system 1000A further includes a light detection system, which in the present example is formed by two detection units 16 and 27; and a light directing system, generally at 17, configured for directing and focusing the recording/reproducing beam L₁ onto a desired location in the medium 10 and for directing light returned from the medium towards the detection system. The detection unit 16 is associated with its collection optics 15 (formed by two lenses in the present example) and serves for detecting a light response LR of the medium to the reading beam. The detection unit 27 is also associated with its imaging optics 26 (e.g. two lenses) and serves for detecting reflection R_{ref} of the reference beam from the reference layer 2. Also provided in the system 1000A is a control unit 30, connectable to the light source system and the detection system (via wires or wireless signal transmission as the case may be), and operating to adjust the operational mode of the light source system and receive and analyze the output of the detection system. Further optionally provided in system 1000A is a controllably movable reflector unit 28 (e.g. mirror driven for movement by a piezo-element) accommodated in the optical path of the recording/reproducing beam L₁, for the beam wobbling purposes and/or for co-aligning the beams, as will be described further below.

The recording/reproducing laser source unit 11 includes a light source capable of emitting light of a wavelength range suitable to cause the multi-photon interaction (e.g. two-photon interaction) for the data recording/reproducing in the data carrier 10, for example a wavelength λ₁ of about 671 nm. The laser source 11 is configured for controllably varying the output thereof such that it selectively emits a light pattern suitable for recording and reading processes, for example light of an average output of 1 W and a pulse(s) width of about tens to hundreds of pico-seconds for recording and light of an average output of 0.1 W and pulse(s) width of about tens of pico-seconds for reading.

The reference laser source unit 21 includes a light source operable for tracking servo and focusing servo of the data carrier 10. This light source emits the reference light beam (laser beam) L₂ of a suitable wavelength range (which may be different or not from that of the recording/reproducing beam), for example having a wavelength 2 of about 780 μm. The reference light source unit preferably also includes a polarized beam splitter 22 and a polarization rotator (e.g. ¼-wavelength plate) 23 in the optical path of the emitted reference beam L₂.

The light directing and focusing system 17 includes a beam splitter/combiner 12 in the optical path of the recording/reproducing and reference beams L₁ and L₂; a focusing optics 24 (formed by one or more lenses for example—two such lenses being shown in the present example) at the output of the reference light system configured for focusing the reference light beam L₂ (of the appropriate polarization) onto the beam splitter/combiner 12; and a focusing/collecting optics 14 (formed by one or more lenses—two such lenses being shown in the present example) for focusing the incident light (optical beam) onto a desired location in the medium and collecting light returned from the medium. Further provided is a mirror 13 accommodated in the optical path of the incident light propagating from the beam splitter/combiner 12 to direct it to the optical data carrier 10 and to direct light returned from the data carrier to the beam splitter/combiner 12. The focal depth of optics 14 defines the thickness of the non-recording layer 3: the thickness of this layer is equal to or larger than the focal depth of optics 14.

The system 1000A operates as follows: The reference beam L₂ is directed towards the medium as described above, i.e. its polarization is preferably appropriately adjusted; and then it is focused by optics 24 onto the beam combiner 12, reflected by the mirror 13, and further focusing by the optics 14 onto the reference layer 2. This reference light is reflected from the reference layer 2 and the reflection R_{ref} returns back through the same optical path, i.e. optics 14, mirror 13, beam splitter/combiner 12, optics 24 and polarized beam splitter 22. The latter reflects the beam R_{ref} to pass through the imaging lens 26 to the detector 27. Based on the output signal from the detector 27 (being analyzed by the controller 30), the operation of the focusing optical systems 14 is controlled such that the focused position of the reference beam L₂ is always substantially coincident with the reference layer 2. Considering for example a four-part split detector is used in the detection unit 27, tracking control can be executed using a well-known push-pull method.

The recording/reproducing beam L₁ in turn passes the beam splitter/combiner 12, is reflected by the mirror 13, and focused in the data carrier 10. In this example, optical axes of the recording/reproducing beam L₁ and the reference beam L₂ are coincided mechanically in advance and are kept coincided throughout the operation (e.g. using the piezo mirror 28).

A focusing position of the recording/reproducing beam L₁ in the disk thickness direction can be controlled by driving the collimator lens pair 24, while a focused position of the reference beam L₂ is kept on the reference track (pattern) in the reference layer 2 through the action of the controller 30 and the focusing optical system 14. Focused position is determined based on the first interface D₁, that is the interface between the recording layer 4 and the non-recording layer 3 (bonding layer). Position of the first interface D₁ can be detected by moving the focused position of the recording/reproducing beam L₁ by the action of the collimator lens pair 24 and detecting an inflexion point of the fluorescent light intensity detected at the detector 16. Further moving the focused position of the recording/reproducing beam L₁ by the action of the collimator lens pair 24, the second surface D₂ that is an upper surface of the recording layer 4 in the present example (or an interface between the recording layer 4 and top substrate 1 in the example of FIG. 1B, or an interface between the recording layer 4 and non-recording layer 3′ in the example of FIG. 1C) is detected by detecting an inflexion point of detected fluorescent light intensity at detector 16. Calculating a distance between two inflexion points of the detected fluorescent light intensity and comparing this distance with a certain value predetermined by a standard or given data contained in the disk, the scale of detection mechanism can be calibrated. The focused position of the recording/reproducing beam L₁ is set based on the calibrated value and the position of the first interface D₁.

The thicknesses of the non-recording layer and the recording layer are preferably substantially uniform in the data carrier. Practically, however, some deviation might exist. In such case, the position should be determined under a predetermined rule. It should be understood that measuring the thickness of recording layer does not signify measurement of a correct value, but rather getting a scale for measuring the distances between the recording planes. So it is important to carry out such measure under the same rule, predetermined as the standard, during data recording and reproducing procedures. One such method consists in getting the minimum thickness, such that the recording plane does not go out from the recording layer. This can be implemented by defining the interface D₁ as the furthest point at some radius in the interface to the reference layer and the interface D₂ as the nearest point at the same radius with respect to the reference layer. Generally, other definitions, such as an average, etc., can be used, but the use of the abovementioned definition is preferred because by such a method the calculated position of the recording/reproducing beam in between those interfaces will always be within the recording layer 4. By using such a scale, the distance between the recording layer interfaces can be measured in a reproducible way even if different optical devices are used in the recording and reproducing process and/or the recording and reproducing device(s) is/are replaced or their parameters are changed from time to time, or if the thickness of the data carrier is changed for some reason, for example as a result of absorption of humid. The reason for the robustness is associated with that the scale is contained in the optical data carrier itself.

By controlling the intensity of the recording/reproducing beam L₁ to be of the intensity suitable for recording, the fluorescent property of the recording layer 4 (constituting the medium excitation by multi-photon interaction) varies on the focused position, resulting in execution of data recording. During the data reading process, when the recording/reproducing beam L₁ is focused on the recorded position, fluorescent light LR (constituting the light response of the data carrier) is emitted in accordance with the condition on the interrogated (recorded mark or space) position. The fluorescent light LR is then guided through the lens system 15 to the detector 16, and, based on the detected signal, the recorded data pattern can be reproduced. To form the beam spot of the recording/reproducing beam L₁ precisely on a desired recording plane in the recording layer 4, the optical system 14 is preferably configured as a spherical aberration-corrected optical system. This actually means that the focusing optical system 14 is designed such as not to cause any spherical aberration higher than a predetermined tolerance. As for the reference beam L₂, small spherical aberration is generally allowed.

FIG. 2B shows another example of an optical system, generally designated 1000B, for recording/reproducing data in an optical recording medium 10. To facilitate understanding, the same reference numerals are used for identifying components that are common in the examples of FIGS. 2A and 2B. As can be seen, the system 1000B is configured generally similar to the above-described system 1000A, distinguishing therefrom in that the system 1000B also includes a polarizing unit formed by a polarization beam splitter 31 and a polarization rotator 34, a lens system 32, and a detector 33, all appropriately accommodated and operated together for collecting and detecting reflection R_{rec/rep} of the recording/reproducing light beam from the reference layer 2. Also, in this example, wavelengths of the recording/reproducing beam L₁ and the reference beam L₂ are different. Also, the light directing and focusing system 17 might utilize a controllably movable reflector unit 28 (e.g. piezo-mirror) accommodated in the optical path of the recording/reproducing beam L₁, for the purpose that will be described further below.

In the example of FIG. 2B, the axes of propagation of the recording/reproducing beam L₁ and the reference beam L₂ need not be mechanically coincided in advance as in the embodiment of FIG. 2A. Both beams L₁ and L₂ are aligned by an optical method every time when the data carrier undergoes recording or reading. Thus, the specifically polarized recording/reproducing beam L₁ emitted by the light source 11 passes through the polarization beam splitter 31, is appropriately rotated by polarization rotator 34, and impinges onto the beam splitter 12 which reflects it towards mirror 13, to propagate as described above with reference to FIG. 2A. This beam L₁ is reflected from the reflective reference layer 2, and this reflection R_{rec/rep} is collected by optics 14, and reflected from beam splitter 12 towards the polarizing unit to be reflected from the beam splitter 31 to pass to the detector 33 via the imaging lens system 32.

According to the invention, alignment of the propagation axes of the recording/reproducing beam L₁ and the reference beam L₂ can be achieved using, for example, reference tracks in the data carrier detectable for both beams. The reference track is formed as a pattern in the reference layer 2, where the pattern may be in the form of an array of spaced-apart pits and/or grooves as described above (the array may be arranged in a concentric or spiral form).

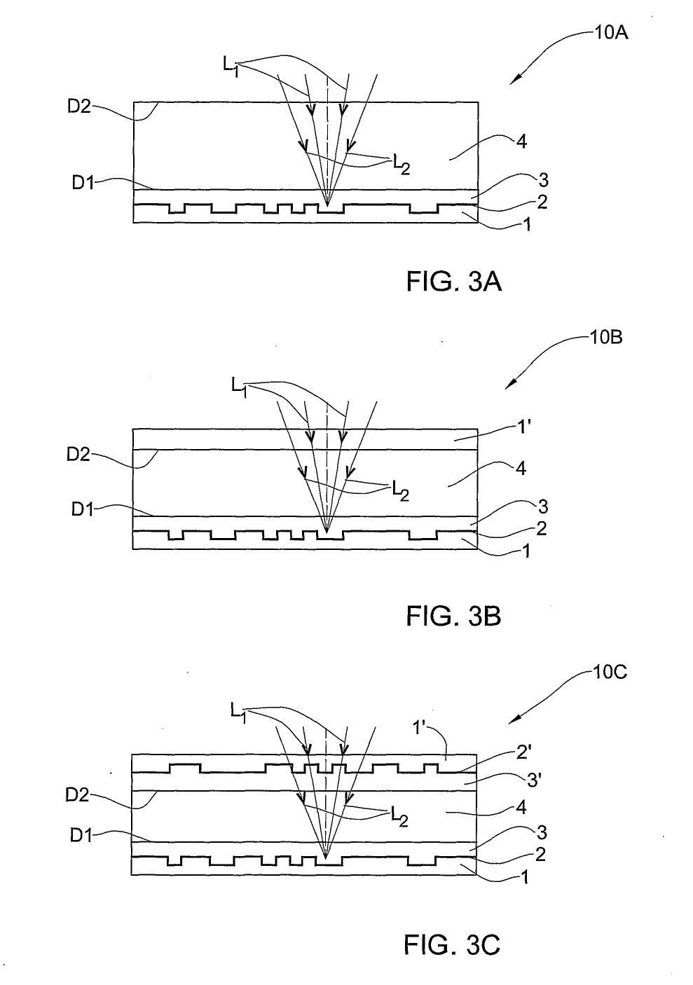

Examples of the optical data carriers with the patterned reference layer are shown, in a self-explanatory manner, in FIGS. 3A-3C based on the data carriers structures of FIGS. 1A-1C, respectively. As shown, and array of pits, generally at 201, is provided in the reflective layer 2.

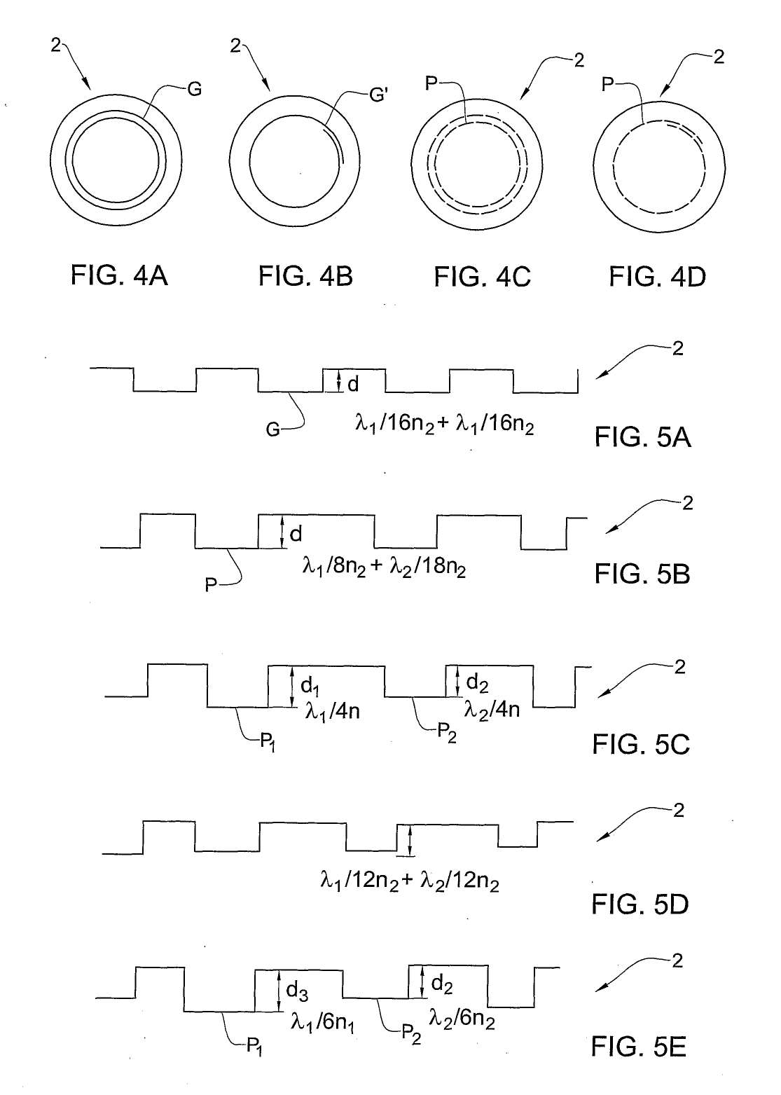

As indicated above, in some embodiments, the spaced-apart discrete pits are formed in a planar surface of the reference layer. In some other embodiments, a single spiral groove or a plurality of concentric closed-loop (e.g. circular) grooves spaced from one another by land regions are formed in a planar surface of reference layer. In yet other embodiments, both of the spaced-apart discrete pits and grooves are formed in a planar surface of the reference layer. FIGS. 4A-4D show some specific, but not limiting examples, of the reference layer pattern. FIG. 4A illustrates concentric grooves, generally at G and FIG. 4B illustrates a spiral groove G′. FIG. 4C shows an array of pits, generally at P, arranged along concentric circular arrays (which may or may not be constituted by grooves); and FIG. 4D exemplifies an array of pits P arranged in a spaced-apart relationship along spiral paths (which may or may not be constituted by groove).

In order to use the optical data carrier for aligning the optical axis of the system exemplified in FIG. 2B the pits preferably have a depth selected for the proper detection of not only the reflection R_{ref} of the reference beam L₂ but also the reflection R_{rec/rep} of the recording/reproducing beam L₁ from the reference layer 2.

It should be understood that, generally, the structure of the reference layer is selected such as to enable guiding of the reference beam and indicating the position information. In order to achieve this, reference layer has a pattern in the form of pits and/or grooves.

In the above-described example of FIG. 2A, the data carrier has the reference layer with the pattern in the form of pits and grooves of proper depth and width for detecting a tracking error signal and an information signal by the reference beam L₂. On the other hand, in the case of the system shown in FIG. 2B, the pits and grooves have proper depth and width for detecting a tracking error signal and an information signal for both the reference beam L₂ and the recording/reproducing beam L₁.

It should also be noted that in the case of a groove structure, for the purpose of detecting the tracking error signal by the use of push/pull method, the groove of a substantially rectangular cross section and a depth d of about (λ₁/16n₁+λ₂/16n₂) is preferably used, where n₁ and n₂ are refractive indices of the non-recording material interfacing with the reference layer upstream thereof (in a direction of propagation of the optical beam towards the reference layer) at, respectively, the wavelength λ₁ of the reference beam L₂ and the wavelength λ₂ of the recording/reproducing beam L₁. This is exemplified in FIG. 5A showing a groove portion in the reference layer, presented as a cross-sectional view (radial direction) of the data carrier. The geometry of the groove is appropriately selected, and may not be of a rectangular cross section, but rather may be of a trapezoid cross section, or U-shape. Thus, the depth and width of the groove are optimized according to the selected shape of the groove.

In the case of pits array structure is used for sampled servo method, it is preferred to use the pits of a substantially rectangular cross section and a depth d of about (λ₁/8n₁+λ₂/8n₂). This is exemplified in FIG. 5B showing a pit-formed portion in the reference layer, presented as a cross-sectional view (circumferential direction) of the data carrier. When pits are used for a push/pull method, the preferable depth of the pits is about (λ₁/12n₁+λ₂/12n₂), as shown in FIG. 5D.

A “mixed” array of pits with different depths d₁ and d₂ of, respectively, λ₁/4n₁ and λ₂/4n₂ may also be used in the sampled servo system. This is exemplified in FIG. 5C, showing such pits P₁ and P₂ of different depth d₁ and d₂, respectively. Also, mixed array of pits with different depths d₃ and d₄ of respectively, λ₁/6n₁ and λ₂/6n₂, may be used in the case of push/pull method, as shown in FIG. 5E.

Turning back to FIG. 2B, in order to detect the reflection R_{rec/rep} of the recording/reproducing beam L₁ from the reference track in the reference layer 2, the wavelength selective mirror 31, lens system 32 and detector 33 are used. The wavelength selective mirror 31 has a wavelength selective reflection surface 31′ configured such that it reflects light of the wavelength of the recording/reproducing beam L₁ (thus reflecting light R_{rec/rep} towards the detector 33) and transmits light of the wavelength of the reference beam L₂ (thus transmitting light R_{ref}). Optically selective filters may also be used. After the reference beam L₂ is focused on the reference track in the reference layer 2 as described above, the reflection R_{rec/rep} of the recording/reproducing beam L₁ from the reference layer 2 is guided by the mirror 31 and lens 32 to the detector 33 which is, for example, a four-part detector, and based on the output of this detector (which is also connectable to the control unit 30) the focus of the recording/reproducing beam L₁ along the optical axis is adjusted on the reference layer 2 by operating the collimator lens pair 24 while working focusing optical system 14, using for example push-pull method.

Then, the focus of the recording/reproducing beam L₁ is tracked on the reference track (pattern in the reflective reference layer 2) by operating the piezo mirror 28. Typically the recording/reproducing beam L₁ is tracked on the same track as the reference beam L₂ and tangential position is also coincided to the same position as the reference beam L₂, but different tangential position may be possible. In order to keep two beams substantially coinciding, the track number and position information included in the reference layer are used (similar to synchronization information for the tangential position information).

By the operation described above, even if the propagation axes of both the recording/reproducing and reference beams are not mechanically coincided in advance as in the first embodiment of FIG. 2A, the two beams can be aligned.

Focusing the recording/reproducing beam L₁ onto a certain recording plane in the recording layer 4 is set by moving the collimator lens pair 24a distance calculated from the information described above. When the collimator lens pair 24 is moved, the focusing optical system 14 is controlled to move such that the reference beam L₂ is kept focused on the reference layer 2 and the focusing point of the recording/reproducing beam L₁ changes accordingly.

As indicated above, in some embodiment of the invention, a calibration procedure is carried out for controlling the moving distance, based on the determination of the fluorescent response from the data carrier to identify interfaces of the recording layer, namely the at least one interface between the recording layer and the at least one non-recording layer, respectively. In some other embodiments of the invention, a calibration procedure utilizes determination of the reflection of the recording/reproducing beam from the reflective interfaces 2 and 2′ (see FIG. 1C).

Thus, one possible method of calibration of the above described moving distance of the collimator lens pair 24 consists of comparing a certain predetermined value (chosen to be a standard), for example the thickness of the data carrier 10, with the actually measured moving distance between the upper and lower interfaces D₁ and D₂ (see FIGS. 1A-1C) of the recording layer 4.

Tracking and controlling the position of the recording/reproducing beam L₁ can be realized by keeping a constant relative position of the recording/reproducing beam L₁ based on the reflection of the reference beam L₂ from the reference layer 2 and following the reference beam L₂ along the reference track in the reference layer 2. It should be understood that mainly the focused position of the recording/reproducing beam is fixed apart to the reference beam and moves with the reference beam. Even in the case of wobbling, the reference beam is wobbled and the recording/reproducing beam wobbles accordingly, and optimization is done as offset of the wobbling center. Another possible procedure consists of independently wobbling the recording/reproducing beam, while the recording/reproducing beam follows a movement of the reference beam (with a certain controlled relation between them). So, the relative position is determined with respect to the reference layer which is always tracked by the reference beam.

The pits in the reference layer are used in tracking of the reference beam L₂ and the recording/reproducing beam L₁ in the tracking and focus directions and for indicating the radial and tangential position. Therefore, the pits are formed to detect focusing of the reference beam L₂ on the reference layer 2 and in some embodiments to detect recording/reproducing beam L₁ on the reference layer 2 as will be described in more details further below.

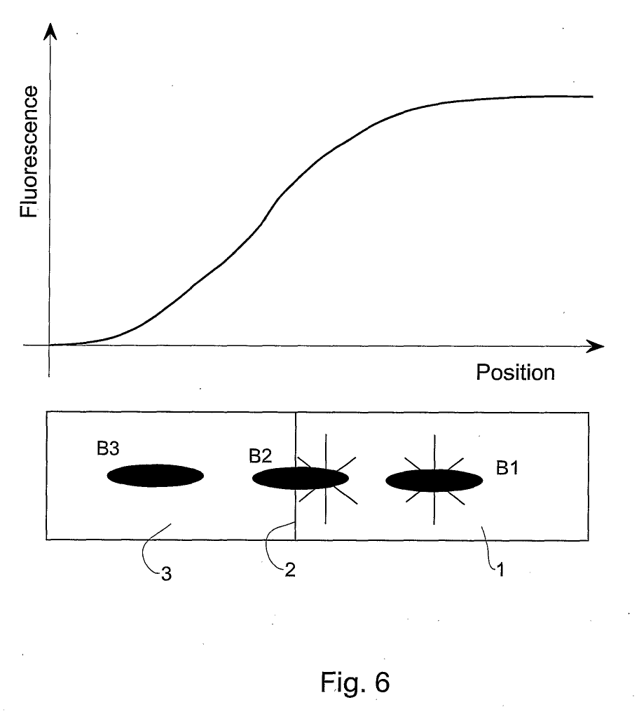

The principle of detecting the interface between the recording layer and the non-recording layer or the surface of the recording layer, by recording/reproducing beam L₁ will now be described with reference to FIG. 6.

As described above, the recording layer 4 and the non-recording adhesive layer 3 have different fluorescent properties. It is assumed herein that the recording layer 4 in its initial non-recording state has a fluorescent property (e.g. is excitable by two-photon interaction to fluoresce) and the non-recording adhesive layer 3 has no fluorescent property. In this case, as shown in FIG. 6, when a recording/reproducing beam L₁ spot is located entirely in the recording layer 4 (position B₁), the amount of fluorescence reaches its maximum; when the recording/reproducing beam spot is located partially (half) in the recording layer 4 (position B₂), the amount of fluorescence exhibits a part (half) that of position B₁, or a middle value; and when the recording/reproducing beam spot is located entirely in the non-recording adhesive layer 3 (position B₃), the amount of fluorescence reaches its minimum. If the focused position of the recording/reproducing beam L₁ is controlled to a position with the middle amount of fluorescence, calibration between the recording/reproducing and reference beams L₁ and L₂ can be executed.

Turning back to FIG. 5C, two types of pits P₁ and P₂ formed in the reference layer 2: pit P₁ is used for detection of the reference beam L₂, and pit P₂ is used for detection of the recording/reproducing beam L₁.

As described above with reference to FIGS. 1C and 3C, the optical data carrier includes the recording layer 4 sandwiched between two reference layers 2 and 2′ arranged in the vertical direction. With this configuration, the thickness of the recording layer 4 can be measured using the calibration procedure, and, based on the result, the number of recording planes formed in one recording layer 4 and the interval therebetween can be controlled.

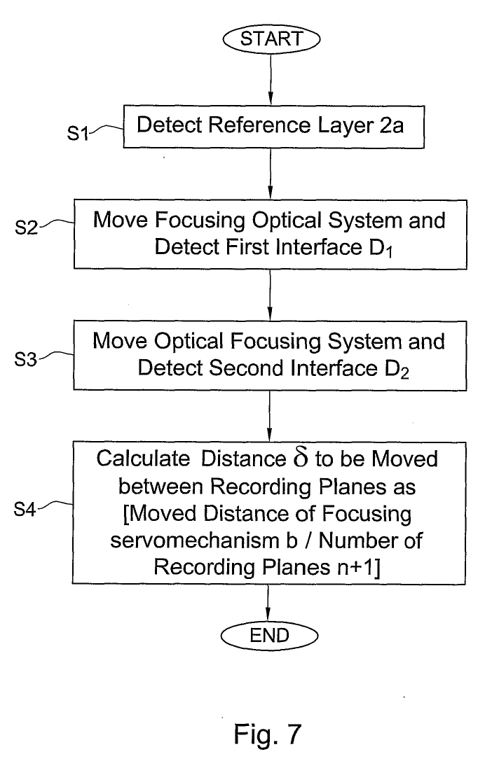

Reference is now made to FIG. 7 exemplifying a method of the present invention for determining a distance between the recording planes, for the optical data carrier configuration of FIGS. 1C and 3C. First, the reference layer 2 is detected (step S1). To this end, a reference beam L₂ is irradiated and focused onto the reference layer 2 using a servomechanism (controller 30 in FIGS. 2A and 2B), and analyzing detection of the reflection of the reference beam from the data carrier.

Subsequently, focusing optics (24 in FIGS. 2A and 2B) is appropriately moved while the focused position of reference beam L₂ is maintained on the reference layer using a servomechanism operated by the controller 30. The movement of the optical system is controlled by monitoring the intensity of the fluorescent light, thereby enabling detection of the first interface D₁ (as described above referring to FIG. 6) (step S2). The focus position of the recording/reproducing beam L₁ is moved up to the inflexion point of the fluorescent light intensity of the beam L₁. In this case, since the position of the piezo mirror 28 (FIG. 2B) is kept fixed while the focus position of the beam L₁ is moved, the optical axis of propagation of the recording/reproducing beam L₁ is kept such that it coincides or is kept in relatively constant relation with the optical axis of propagation of the reference beam L₂. Thus, by appropriately moving the optical system, the inflexion point of fluorescent intensity is detected when the focus position of the beam L₁ coincides with the other interface D₂ (step S3).

A distance b of the movement of focus position of the recording/reproducing beam L₁ (a distance between the interfaces D₁ and D₂) is then determined by the control unit. Based on this moved distance b, when N recording planes are formed in one recording layer, a distance δ to be moved between the adjacent recording planes can be determined as δ=b/(N+1) (step S4).

A calibration of the focusing servomechanism is performed as described above. After the completion of this calibration procedure, actual data recording by the recording/reproducing beam L₁ can be started. During the recording procedure, the focus position of the reference beam L₂ is kept on a reference track in the reference layer 2 (via the operation of the servomechanism), and the piezo mirror 28 is kept in a fixed state. Accordingly, the optical axis of the recording/reproducing beam L₁ propagation is kept such that it coincides or is in a constant relative position with the optical axis of the reference beam L₂ propagation. In this situation, by increasing the intensity of the recording/reproducing beam L₁, data recording may be conducted.

A procedure for determining a distance between the recording planes in the data carrier exemplified in FIG. 3A or FIG. 3B is similar to the above described method. By performing a calibration using this method, effects caused by individual differences between recording media, change in characteristics with time, differences in the recording/reproducing devices or the like may be restrained, thereby allowing recording/reproducing with high accuracy.

It should be noted that as to the distance b between the interfaces D₁ and D₂ and the number N of the recording planes, a value provided by a standard can be used as is, i.e. as specified by the standard. Alternatively, when various types of standards exist, specific information about the standard to be used may be recorded in the reference layer 2 of the data carrier, and this information may then be read from the reference layer when the medium is used to set the desired distances between the recorded layers in the medium and between the recorded layers and the corresponding layer(s).

On data reproducing, the position of data layer can be detected roughly by above mentioned method. It should be noted that sometimes, for example when the data carrier is tilted or the setting is decentered, the actual position of data layer might differ from the calculated position. In order to get an optimal signal, adjustment of the tracking by fine servo might be necessary.

Preferably, on data reproducing from the data carrier 10, the recording/reproducing beam is driven at a certain cycle (wobbling frequency f₁) while setting, as a reference, a constant relative focused position of the reproducing beam L₁ relative to the focused position of the reference beam L₂ on the reference track in the reference layer, to vary the focused position of the reference beam L₂ in the data carrier thickness direction. In other words, in this specific example, the reproducing process proceeds while scanning within a nominal plane (ideally, the so-called “flat spiral” movement of the recording/reproducing beam) with a small wobble perturbation. Turning back to FIG. 2A or FIG. 2B, such wobbling of the recording/reproducing beam can be achieved by appropriately operating the piezo-mirror 28. Another option, which may be used separately or additionally to the above described technique, the wobbling effect of the recording/reproducing beam can be achieved as follows: The optics 24 is appropriately displaced resulting in a change in the distance between the focus of the reference beam and the recording/reproducing beam. The optics 14 is displaced accordingly, resulting in the wobbling of the recording/reproducing beam while keeping the focal position of the reference beam to be on the reference layer. Yet further option consists of manipulation of the optics 14 by using therein a liquid crystal optical element that is capable of small and rapid manipulation of the beam divergence, such element may be inserted in between the lenses of the optics 14. It should be noted that when utilizing wobbling of the recording/reproducing beam during the data recording process, the wobbling phase would be detected during the data reproducing.

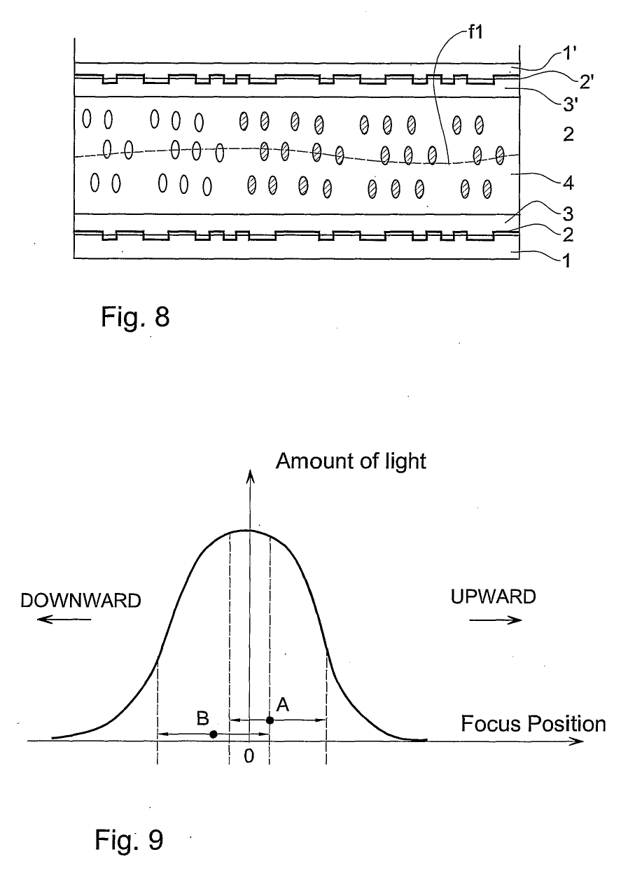

Thus, as a result, as shown in FIG. 8, the focused position of the recording/reproducing beam L₁ during reading is wobbled, with the wobbling frequency f₁, in the data carrier thickness direction (wobbling in the optical axis direction). In such a scheme, the intensity of the reproduced (read) signal varies at the detector (16 in FIGS. 2A and 2B) in accordance with the variation cycle of the focused position. Accordingly, even if only one detector 16 for data reading is provided as in FIGS. 2A and 2B, an optimal focused position of the recording/reproducing beam L₁ can be specified. Various detection methods are described in WO 03/070689 and WO 2005/015552 assigned to the assignee of the present application. Thus, the focused position can be controlled precisely on the recording plane.

FIG. 9 shows a relation between the focused position of the recording/reproducing beam L₁ (when the position of the recording plane to be read is determined as zero position) and the amount of fluorescence received at the detector (16 in FIGS. 2A and 2B). When the focused position of the recording/reproducing beam L₁ is precisely coincident with the recording plane while wobbling about the position in the focus direction, the amount of light received at the detector 16 on vibrating upward is almost equal to that on vibrating downward. On the other hand, as shown by A in FIG. 9, when the focus position is shifted upward from the correct position, the reduction in the amount of fluorescent light on vibrating upward becomes larger than that on vibrating downward in wobbling in the focus direction. To the contrary, as shown by B in FIG. 9, when the focus position is shifted downward, the reduction in the amount of light on moving upward becomes smaller than that on moving downward in wobbling in the focus direction. This fact is indicative of whether the focus position is shifted upward or downward. The focus position can be controlled such that the reduction in the amount of fluorescent light on moving upward coincides with that on moving downward. In this case, even a single detector can control focusing of the recording/reproducing beam L₁. The example of FIG. 9 is schematic. It should be noted that the comparison can also be performed in the case the fluorescence signal from the space surrounding the data pattern (regions in the data carrier outside the recorded track) is higher than the signal from the recorded regions. Comparison of the average modulation depth (the relative difference between the signal from the recorded regions and signal from the spaces) at opposite phases of the wobbling cycle is also possible. By performing wobbling while setting as a reference a position relatively apart from the reference track in the reference layer 2, the tracking signal error may be minimized and a stable tracking may become easy, even if a deformation or the like of the data carrier occurs.

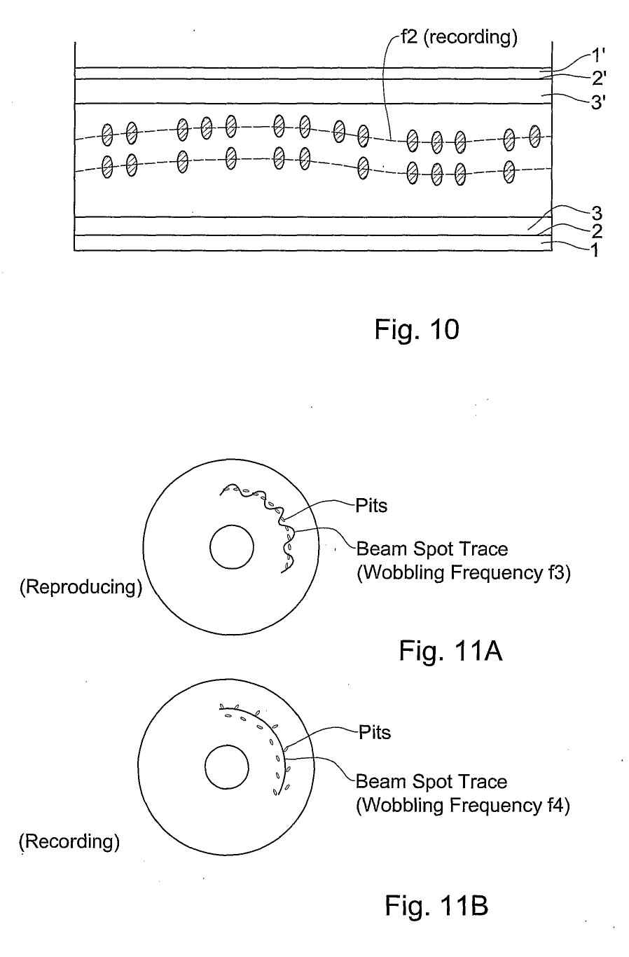

Reference is made to FIG. 10, showing that not on data reproducing from the data carrier but on recording therein, the focused position of the recording/reproducing beam L₁ may be wobbled in the optical axis direction at a certain wobbling frequency f₂, while reading proceeds in the recording plane. It should, however, be noted that as the layers practically have not-precise planarity, because of the manufacturing process, the plane scanning is adjusted accordingly. In this case, focusing control can be executed on reproducing not to follow the wobbling frequency f₂ with the same effect as above.

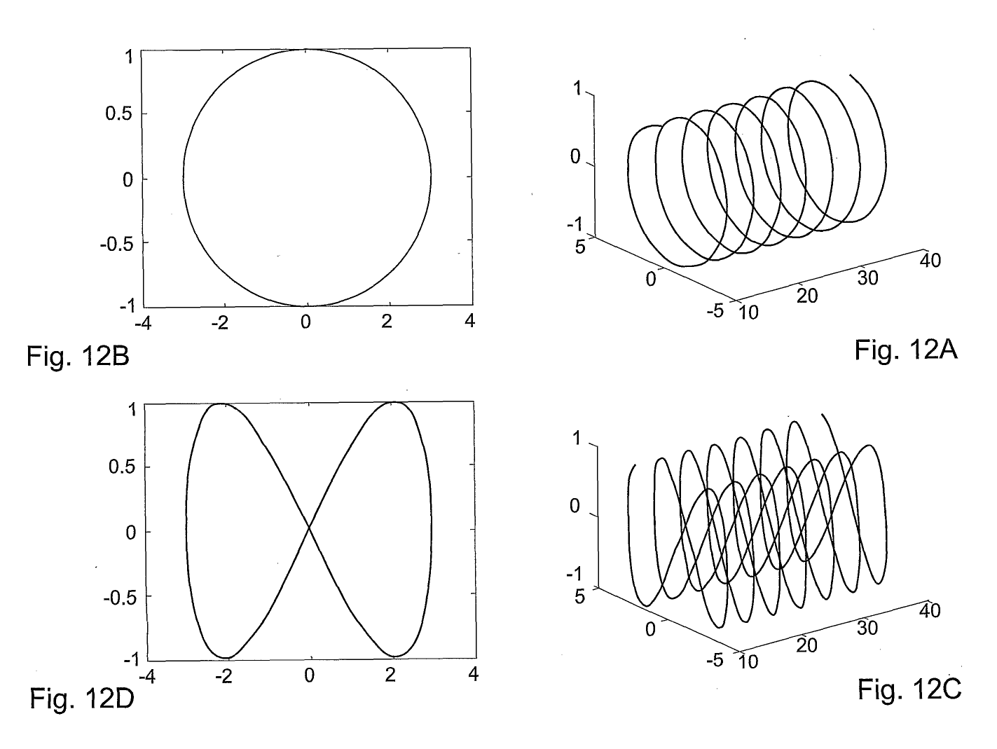

As shown in FIGS. 11A and 11B, a similar concept is applicable to tracking control. When upward is substituted to outer-side and downward to inner-side in FIG. 9, optimum position will be detected in the same manner, on reproducing or on recording. In this case, wobbling can be executed at certain wobbling frequencies f₃, f₄ for reproducing and recording, respectively. To distinguish between the focusing control and the tracking control, the wobbling in the optical axis direction (focus direction wobble) is different from the wobbling in the radial direction (tracking direction wobble) in at least one of frequency and phase. Then, these two frequency components are separated and extracted in the reproduced (read) fluorescent signal, for the above described processing. By performing the above-described calibration, roughly aligning the focus position of the recording/reproducing beam L₁ to one of the recording planes based on the calibration result, and conducting wobbling on the basis of the rough-aligned position, a sensitive alignment of the recording/reproducing beam L₁ can be performed.

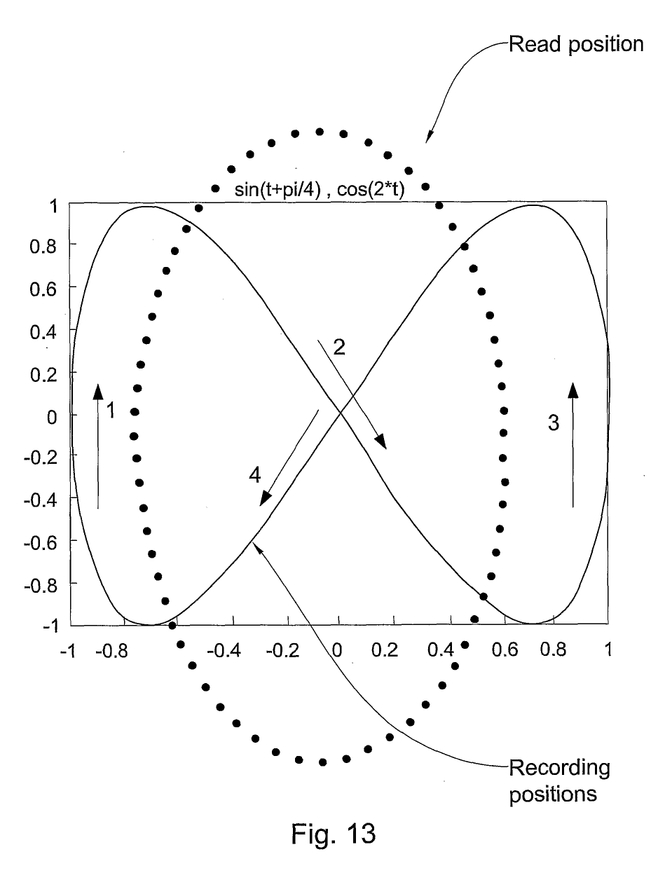

Reference is now made to FIGS. 12A-12D and FIG. 13 describing possible structures of the recorded track. FIGS. 12A-12D show an embodiment in which the frequency of the modulation of the spot position in the radial direction is the same as in the axial direction. As shown in FIGS. 12A and 12B, the recorded track forms a small cycle around a nominal position that is of helical form where a ratio between the amplitudes of the modulation in the radial and axial directions determines the ellipticity of the helix. A phase difference of π/2 between the modulations is used. The focus error signal (FES) and tracking error signal (TES) may be derived by a first step phase locking on the amplitude modulation of the signal when being approximately on track and a second step of deriving the error signals using for example output of a window integrator (with a window size T) of the form:

$${err}_{i} ( t ) = {\int }_{t - T}^{t} {m}_{i} \cdot I ( t ) d t$$

where the index i refers to the specific error signal (FES or TES), mᵢ is the derived phase locked internal signal, and I(t) is the detected fluorescent signal from the medium.

The beam position approximately on track can be achieved by using the controlled distance from the reference layer, by a slow motion in either one of the radial and axial directions and by the fact that a spiral shape of a track helps to be approximately on track in a ‘once around’ fashion.

As noted above, using two frequencies is also a method for separating between the signal components for the FES and TES. FIGS. 12C and 12D show another embodiment of the recorded pattern. In this embodiment the form of the track is more complex. Where both the phase difference and the frequency difference are used for the focusing and tracking control, the error signals FES and TES can be derived. In this specific embodiment, the modulation frequencies and phases are chosen to be (sin(t+pi/4), cos(2*t)), the resulting form of the track is a complex helix with a cross over in the center of the nominal track. FIG. 12C shows a 3D plot of an exaggeration of the track to qualitatively show its shape. FIG. 12D illustrates a projection of the track relative to the nominal track position. As shown more specifically in FIG. 13, a Lissagou pattern is formed in this projection by the nominal recorded track. The dotted ellipse shows the relative position of the read beam in this projection. Arrows 1-4 schematically show that once there is a phase lock to the track signal, the motion relative to the nominal track can be derived and therefore the read beam is not required to modulate. As the required motion of the read beam focus relative to the nominal track is known, the position correction can be performed.

Those skilled in the art will readily appreciate that various modifications and changes can be applied to the embodiments of the invention as hereinbefore described, without departing form its scope defined in and by the appended claims.

1. An optical data carrier, comprising:
at least one recording layer comprised of a material having a fluorescent property variable on occurrence of multi-photon absorption resulted from an optical beam, said recording layer having a thickness for recording therein data in the form of a three-dimensional pattern of spaced-apart recording regions arranged in a plurality of recording planes;
at least one non-recording layer interfacing with said recording layer on, respectively, at least one of upper and lower surfaces of said recording layer, said at least one non-recording layer having a fluorescent property different from that of said recording layer, said non-recording layer having a predetermined thickness selected to be equal or larger than a focal depth of an optical system producing said optical beam incidence onto the data carrier; and at least one reflective interface comprising at least one reference layer having a reflecting property, said at least reflective layer being formed on the other surface of said at least one non-recording layer, such that the non-recording layer in sandwiched between the reference layer and said recording layer.

2. The optical data carrier according to claim 1, wherein the thickness of said non-recording layer is in the range of 3 μm to 80 μm.

3. The optical data carrier according to claim 1, wherein the non-recording layer is made of an adhesive material to enable adhering of the recording layer to the reference layer.

4. The optical data carrier according to claim 1, wherein the reflective interfaces comprise an interface between the at least one non-recording layer and said recording layer formed by a difference in refractive indices of the recording and non-recording layers' materials.

5. The optical data carrier according to claim 1, wherein said reference layer has a pattern configured to enable tracking of the optical, reference beam, based on reflections of the optical beam from said pattern, the pattern having one of the following configurations: comprising a plurality of discrete pits, and comprising either a plurality of concentric circular grooves or a spiral groove.

6. The optical data carrier according to claim 1, wherein said reference layer has a pattern thereby enabling tracking of the optical beams of different wavelengths, based on reflections of the optical beams from said pattern.

7. The optical data carrier according to claim 6, wherein said optical beams of different wavelengths are a recording/reproducing beam and a reference beam.

8. The optical data carrier according to claim 5, wherein said pattern in the reference layer comprises the plurality of concentric grooves or by spiral groove, of a groove depth of about λ₁/8n₁, where n₁ is a refractive index of the non-recording layer interfacing with said reference layer upstream thereof in a direction of propagation of the optical beam towards the reference layer, at wavelength 21 of the reference optical beam.

9. The optical data carrier according to claim 5, wherein said pattern in the reference layer comprises the plurality of pits, arranged either along a plurality of concentric circular paths or along a spiral path, the plurality of pits including the pits of a depth of about λ₁/4n₁, where n₁ is a refractive index of the non-recording layer interfacing with said reference layer upstream thereof in a direction of propagation of the optical beam towards the reference layer at a wavelength 21 of the reference beam.

10. The optical data carrier according to claim 5, wherein said pattern in the reference layer comprises the plurality of pits, arranged either along a plurality of concentric circular paths or along a spiral path, the plurality of pits including the pits of a depth of about λ₁/6n₁, where n₁ is a refractive index of the non-recording layer interfacing with said reference layer upstream thereof in a direction of propagation of the optical beam towards the reference layer at a wavelength 21 of the reference beam.

11. The optical data carrier according to claim 9, wherein said concentric circular paths or said spiral path are constituted by grooves.

12. The optical data carrier according to any one of claim 1, wherein said reference layer has a pattern configured to enable tracking of the optical, recording/reproducing beam based on reflection of said recording/reproducing beam from said pattern in the reference layer.

13. The optical data carrier according to claim 5, wherein said pattern in the reference layer comprises a plurality of concentric grooves or a spiral groove, the groove depth being of about (λ₁/16n₂+λ₁/16n₂), where n₁ and n₂ are refractive indices at wavelengths λ₁ and λ₂ of the reference optical beam and the recording/reproducing optical beam, respectively, of the non-recording layer interfacing with said reference layer upstream thereof in a direction of propagation of the optical beam towards the reference layer.

14. The optical data carrier according to claim 5, wherein said pattern in the reference layer comprises a plurality of discrete pits arranged either in concentric circular arrays or along a spiral path, said plurality of pits including pits of a depth of about (λ₁/8n₂+λ₂/8n₂), where n₁ and n₂ are refractive indices at wavelengths λ₁ and λ₂ of the reference optical beam and the recording/reproducing optical beam, respectively, of the non-recording material interfacing with said reference layer upstream thereof in a direction of propagation of the optical beam towards the reference layer.

15. The optical data carrier according to claim 5, wherein said pattern in the reference layer comprises a plurality of discrete pits arranged either in concentric circular arrays or along a spiral path and including the pits of a depth of about (λ₁/12n₂+λ₂/12n₂), where n₁ and n₂ are refractive indices at wavelengths λ₁ and λ₂ of the reference optical beam and the recording/reproducing optical beam, respectively, of the non-recording material interfacing with said reference layer upstream thereof in a direction of propagation of the optical beam towards the reference layer.

16. The optical data carrier according to claim 5, wherein said pattern in the reference layer comprises a plurality of discrete pits arranged either in concentric circular arrays or along a spiral path, said plurality of pits including pits of a depth d₁=λ₁/4n₂ and d₂=λ₂/4n₂, where n₁ and n₂ are refractive indices at wavelengths λ₁ and λ₂ of a reference optical beam and a recording/reproducing optical beam, respectively, of the non-recording layer interfacing with said reference layer upstream thereof in a direction of propagation of the optical beam towards the reference layer.

17. The optical data carrier according to claim 5, wherein said pattern in the reference layer comprises a plurality of discrete pits arranged either in concentric circular arrays or along a spiral path, said plurality of pits including pits of a depth d₁=λ₁/6n₂ and d₂=λ₂/6n₂, where n₁ and n₂ are refractive indices at wavelengths λ₁ and λ₂ of a reference optical beam and a recording/reproducing optical beam, respectively, of the non-recording layer interfacing with said reference layer upstream thereof in a direction of propagation of the optical beam towards the reference layer.

18. The optical data carrier according to claim 1, wherein said reference layer comprises position information of radial direction and tangential direction.

19. The optical data carrier according to claim 1, wherein said reference layer comprises information about the thickness of the recording layer.

20. The optical data carrier according to claim 1, wherein said recording layer is enclosed between the first and second non-recording layers, at least one of said first and second non-recording layers interfacing at its opposite surface with said at least one reflective reference layer, respectively.

21. The optical data carrier according to claim 20, wherein the other of said first and second non-recording layers interfaces, at its opposite surface, with the additional reflective reference layer.

22. A method for use in recording/reproducing data in the optical data carrier configured according to claim 1, said method comprising controlling focusing of the recording/reproducing optical beam on each of multiple recording planes in the recording layer, by detecting at least one of the following: reflection of the recording/reproducing and reference optical beams from the at least one reflective interface, and a change of a fluorescent response from the data carrier at interface between the recording and non-recording layers, to thereby enable at least one of the following: aligning the recording/reproducing beam propagation relative to the reference beam propagation and identifying two opposite interfaces of the recording layer with its surroundings.

23. The method according to claim 22, controlling an axis of propagation of the recording/reproducing beam towards and inside the data carrier, by aligning the axis of propagation of the recording/reproducing beam to substantially coincide or be in a desired relation with an axis of propagation of the reference beam.

24. The method according to claim 23, comprising focusing said reference beam onto a desired track in the reference layer and focusing said recording/reproducing beam at either the same track or a track at a desired relative position with said track onto which said reference beam is being focused.

25. A method for use in recording/reproducing data in the optical data carrier configured according to claim 1, the method comprising: calibrating a moving distance of a focused position of the recording/reproducing optical beam along a focus direction, by locating first and second interfaces of the recording layer at opposite sides thereof, thereby determining a thickness of said recording layer.

26. The method according to claim 25, wherein said first and second interfaces are interfaces between the recording layer and its first and second adjacent layers, respectively.

27. The method according to claim 26, wherein said first and second adjacent layers are the first and second non-recording layers at opposite sides of the recording layers, each of the first and second non-recording layers being sandwiched between said recording layer and respectively, the first and second reflective reference layers.

28. The method according to claim 27, wherein said calibrating comprising detecting a fluorescent response from the data carrier to identify location of the first and second interfaces by detecting a change in the fluorescent response.

29. The method according to claim 25, wherein said first and second interfaces are the first and second reflective layers spaced from the recording layer by the first and second non-recording layers, respectively, of known thicknesses.

30. The method according to claim 28, comprising:
keeping the reference beam to follow a reference track in the reference layer, moving the focus position of the recording/reproducing beam along its propagation axis, which is kept to be the same or at a constant relative position with respect to a propagation axis of said reference beam, detecting the fluorescent response from the data carrier induced by said recording/reproducing beam, determining first position information by detecting the first interface between said recording layer and the non-recording layer from the change in the fluorescent response, determining second position information, while further moving the optical beams through the data carrier, by detecting the second interface of said recording layer at opposite side thereof from the change of the fluorescent response, and processing data indicative of the first and second position information to determine the thickness of the recording layer.

31. The method according to claim 28, comprising:
keeping said reference beam to follow a reference track, moving the focus position of the recording/reproducing beam along its propagation axis, which is kept to be the same or at a constant relative position with respect to the propagation axis of said reference beam, detecting the fluorescent response from the data carrier induced by said recording/reproducing beam, getting first position information, which is the furthest position in the first interface from said reference layer, by detecting the first interface which is the interface between said recording layer and said non-recording layer, from the change of the fluorescent response, getting second position information, which is the nearest position in the second interface from said reference layer, while further moving the beams towards and in the data carrier, by detecting the second interface which is the other surface or the interface of said recording layer, from the change of the fluorescent response; and calculating the thickness of said recording layer and comparing the calculated value with a predetermined value recorded in said data carrier or a predetermined standard value.

32. A method for use in recording/reproducing data in the optical data carrier according to claim 1 comprising, determining a radial and tangential position of focusing for the recording/reproducing beam by keeping a focus position of the reference beam to follow a reference track in the reference layer, while an axis of propagation of the recording/reproducing beam is kept at the same track or at another track being in constant relative position with respect to said track on which the reference beam is being focused; and determining a position of the focused recording/reproducing beam along its propagation axis, based on reflection from the at least reflective interface, or in a change in a fluorescent response from the data carrier at an interface between the recording layer and the non-recording layer.

33. A method for use in recording/reproducing data in the optical data carrier according to anyone of claim 1, the method comprising, aligning an axis of propagation of the recording/reproducing beam to coincide or be in a constant relative position with respect to an axis of propagation of the reference beam; and determining radial and tangential focal position of the recording/reproducing beam by keeping a focal position of the reference beam on a reference track in the reference layer.

34. The method according to claim 25 comprising,
detecting and analyzing light from the data carrier in response to the data carrier irradiation by the recording/reproducing beam, said light from the data carrier including at least one of a fluorescent response from the data carrier and reflection of the recording/reproducing beam from the data carrier, said light returned from the data carrier being indicative of a distance between the first and second interfaces, thereby determining a thickness of said recording layer; moving the focal position of the recording/reproducing beam in the recording layer according to a predetermined path based on the location of at least one of the first and second interfaces, using the calibrated moving distance along the beam propagation direction.

35. The method according to claim 22 for use in recording data in the optical data carrier, the method comprising adjusting intensity of the recording/reproducing beam to be of a value selected for the data recording, the focal position of the recording/reproducing beam moved in a predetermined relation to a movement of the focal position of the reference beam that follows a reference track in the reference layer; and carrying out the data recording by modulating the intensity of recording/reproducing beam.

36. The method according to claim 22 for use in recording data in the optical data carrier, comprising moving the focal position of the recording/reproducing beam to a desired position in the recording layer, and while keeping said focal position, moving the recording/reproducing beam in a predetermined relation to a movement of the focal position of the reference beam, and such that the recording/reproducing beam wobbles in a radial and beam direction with predetermined amplitude and cycle.

37. The method according to claim 36, wherein the recording/reproducing beam is wobbles according to wobbling of the reference beam with predetermined frequency and phase, thereby enabling detection of an optimal fluorescent response.

38. The method according to claim 22 for use in reproducing data from the optical data carrier, the method comprising: moving a focal position of the recording/reproducing beam in the recording layer according to a predetermined path; and adjusting intensity of the recording/reproducing beam to a value required for the data reproducing, the recording/reproducing beam moving in a predetermined relation to a movement of the reference beam that follows a reference track in the reference layer.

39. The method according to claim 25 for use in reproducing data from the optical data carrier, the method comprising: moving the focal position of the recording/reproducing beam in the recording layer according to a predetermined path based on the locations of the first and second interfaces, using the calibration data which is provided by detecting the fluorescent response from the data carrier, analyzing said fluorescent response to detect the change therein which is indicative of a distance between the first and second interfaces of the recording layer at opposite sides thereof, and thereby determining the thickness of said recording layer.

40. The method according to claim 38, comprising, after bringing the focal position of the recording/reproducing beam to the desired position, moving the recording/reproducing beam in a predetermined relation with a movement of the reference beam focal position and such that the recording/reproducing beam wobbles in radial and beam propagation directions with predetermined amplitude and cycle, a center of wobbling being moved such that an intensity of the tracking error signal is maximized.

41. The method according to claim 40, wherein the recording/reproducing beam is wobbles according to wobbling of the reference beam with predetermined frequency and phase, thereby enabling detection of an optimal fluorescent response.
